(19) United States
(12) Patent Application Publication
(10) Pub. No.: US 2014/0156047 A1
(43) Pub. Date: Jun. 5, 2014

(54) Manufacturing Process Monitoring and Control System

(71) Applicant: THE BOEING COMPANY, (US)

(72) Inventors: Shuguang Song, Seattle, WA (US); Laurance N. Hazlehurst, Seattle, WA (US); Komson Chaivirat, Bothell, WA (US); Chen-en Chen, Shoreline, WA (US); Roberto F. Lu, Bellevue, WA (US)

(73) Assignee: THE BOEING COMPANY, Chicago, IL (US)

(21) Appl. No.: 13/693,397

(22) Filed: Dec. 4, 2012

(51) Int. Cl. G05B 13/02

(52) U.S. Cl. CPC G05B 13/02
USPC 700/95

(57) ABSTRACT

A method and apparatus for controlling a manufacturing process. Statistical correlations between a plurality of tasks comprising the manufacturing process are identified. The manufacturing process is controlled using the statistical correlations.

### BACKGROUND INFORMATION

1. Field

The present disclosure relates generally to systems and methods for monitoring and controlling a manufacturing process, such as a process for assembling an aircraft. More particularly, the present disclosure relates to identifying statistical correlations between various tasks that comprise a manufacturing process and using the statistical correlations to improve the control of the manufacturing process.

2. Background

A manufacturing process may be defined by a number of tasks. For example, a product may be made by a manufacturing process by completing the number of tasks. The number of tasks that comprise a manufacturing process may be defined in terms of resources that are needed to complete a task, the amount of time that it takes to complete a task from the time that the task is started, and relationships between the tasks.

Controlling a manufacturing process may include scheduling the various tasks that comprise the process and allocating appropriate resources to those tasks in order to achieve desired goals for completing the manufacturing process. For example, one such goal may be to complete the manufacturing process to make a product within a specified time period using specified available resources.

Controlling a manufacturing process also may include monitoring the manufacturing process as tasks are completed and making any necessary adjustments to the task schedule. Controlling a manufacturing process also may include reallocating resources between tasks in response to changing conditions.

Many of the tasks in a manufacturing process may be interdependent. For example, some tasks may not be started until other tasks are completed. It may be desirable to understand the relationships among tasks in a manufacturing process. For example, it may be desirable to identify how the delay of some tasks in the manufacturing process may affect other tasks in the process.

In a large-scale manufacturing process there may be a great number of tasks to be performed. For example, the process of building an aircraft may involve thousands of specified tasks.

Effective control of a manufacturing process may be achieved if the relationships between the tasks comprising the manufacturing process are identified accurately. However, accurately identifying the relationships between the many tasks in a large-scale manufacturing process presents a technical problem.

Effective control of a manufacturing process may be achieved if the status of the manufacturing process may be identified accurately. Manufacturers currently may use various types of charts and other methods to track the status of a manufacturing process. The level of manual effort required to keep such charts updated throughout the manufacturing process may be undesirable.

Furthermore, current methods for monitoring the status of a manufacturing process may not identify the status of the process in a manner that may be used to improve control of the manufacturing process. For example, manufacturers may use the number of tasks behind schedule in a manufacturing process to identify the status of production of an aircraft or other system. Such current methods for identifying the status of a manufacturing process may not identify the status of the process accurately. Furthermore, current methods for monitoring the status of a manufacturing process may not be used to identify accurately the cause of delays in the manufacturing process. Therefore, such current methods may not provide an effective tool for controlling the manufacturing process. Accurately identifying the status of a manufacturing process to improve control of the manufacturing process presents another technical problem.

Accordingly, it would be beneficial to have a method and apparatus that takes into account one or more of the issues discussed above as well as possibly other issues.

### SUMMARY

An illustrative embodiment of the present disclosure provides a method for controlling a manufacturing process. Statistical correlations between a plurality of tasks comprising the manufacturing process are identified by a processor unit. The manufacturing process is controlled using the statistical correlations.

Another illustrative embodiment of the present disclosure provides an apparatus comprising a manufacturing process status monitor and a manufacturing process controller. The manufacturing process status monitor is configured to identify statistical correlations between a plurality of tasks comprising a manufacturing process. The manufacturing process controller is configured to control the manufacturing process using the statistical correlations.

Another illustrative embodiment of the present disclosure provides a method for controlling a process for assembling an aircraft. Statistical correlations between a plurality of tasks for assembling the aircraft are identified by a processor unit. A first task from the plurality of tasks for assembling the aircraft is identified by the processor unit. A number of correlated tasks from the plurality of tasks for assembling the aircraft are identified by the processor unit using the statistical correlations. An effect of a delay in the first task on the number of correlated tasks is identified by the processor unit using the statistical correlations.

The features, functions, and benefits may be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives, and features thereof will best be understood by reference to the following detailed description of illustrative embodiments of the present disclosure when read in conjunction with the accompanying drawings, wherein:

FIG. 1 is an illustration of a block diagram of a manufacturing environment in accordance with an illustrative embodiment;

FIG. 2 is an illustration of a block diagram of a manufacturing process status monitor in accordance with an illustrative embodiment;

FIG. 3 is an illustration of a user interface in accordance with an illustrative embodiment;

FIG. 4 is an illustration of another user interface in accordance with an illustrative embodiment;

FIG. 5 is an illustration of a flowchart of a process for controlling a manufacturing process in accordance with an illustrative embodiment; and

FIG. 6 is an illustration of a block diagram of a data processing system in accordance with an illustrative embodiment.

### DETAILED DESCRIPTION

The different illustrative embodiments recognize and take into account a number of different considerations. “A number,” as used herein with reference to items, means one or more items. For example, “a number of different considerations” means one or more different considerations.

The different illustrative embodiments recognize and take into account that the interdependence of tasks in a manufacturing process may affect the status of the process. In particular, the different illustrative embodiments recognize and take into account that a delay of some tasks in the manufacturing process may affect other tasks in the manufacturing process and may affect the status of the manufacturing process as a whole.

The different illustrative embodiments also recognize and take into account that relationships among tasks in a manufacturing process may be identified to improve control of the manufacturing process. For example, the identified relationships between the tasks in a manufacturing process may be used to find the cause of delays in the manufacturing process, for resource planning, to prioritize tasks, or in another manner or various combination of manners for controlling the manufacturing process.

Illustrative embodiments provide a technical solution to the technical problem of identifying the relationships between tasks in a manufacturing process by identifying statistical correlations between a plurality of tasks comprising the manufacturing process. For example, without limitation, illustrative embodiments may use engineering knowledge and statistical dependence concepts as well as measurements from historical manufacturing data to identify correlated tasks across a manufacturing process.

Illustrative embodiments provide a technical solution to the technical problem of identifying the status of a manufacturing process to improve control of the manufacturing process by controlling the manufacturing process using statistical correlations between the tasks comprising the manufacturing process. For example, without limitation, illustrative embodiments may use the statistical correlations between tasks to identify the effect of delayed tasks on other tasks in the manufacturing process and on the status of the manufacturing process as a whole.

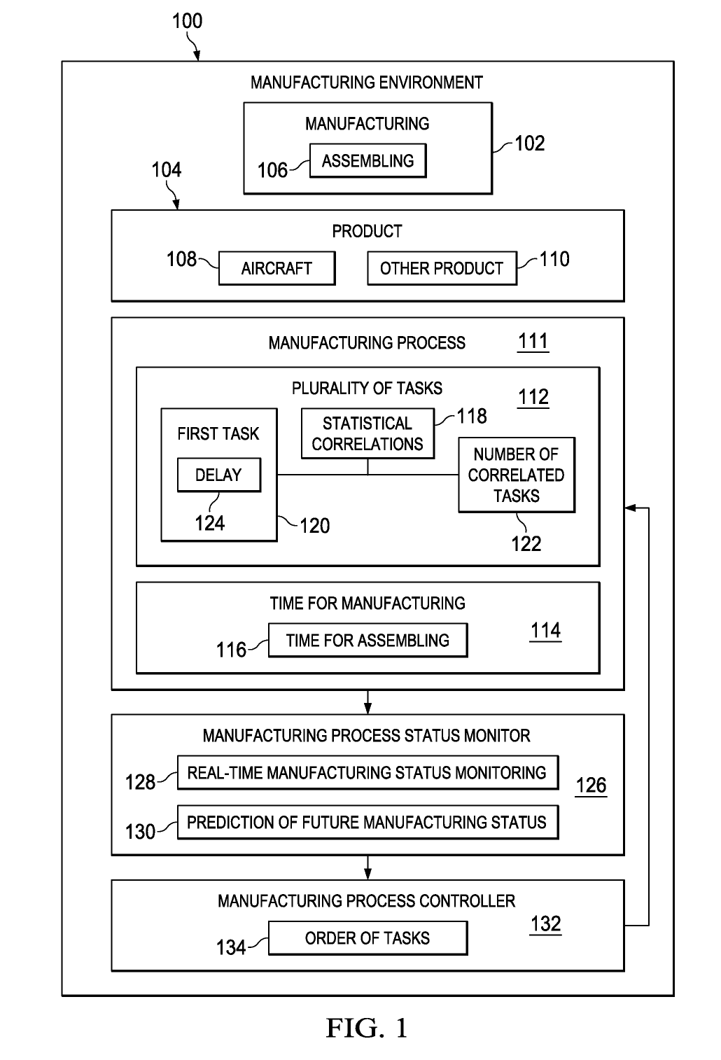

Turning now to FIG. 1, an illustration of a block diagram of a manufacturing environment is depicted in accordance with an illustrative embodiment. In this example, manufacturing environment 100 may include any environment for manufacturing 102 product 104.

Manufacturing 102 may include any process for making product 104 or for making any part of product 104. For example, without limitation, manufacturing 102 may include assembling 106, any other portion of a manufacturing process, or various combinations of processes for making product 104.

Product 104 may be any product that may be made in manufacturing environment 100. For example, without limitation, product 104 may be aircraft 108 or other product 110. Aircraft 108 may be any type of aircraft. For example, without limitation, aircraft 108 may be a commercial aircraft, a military aircraft, a fixed wing aircraft, a rotary wing aircraft, a lighter than air aircraft, a manned aircraft, or an unmanned aircraft. For example, without limitation, other product 110 may be a vehicle, such as an automobile or other land vehicle, a water vehicle, or any other type of product.

Product 104 may be made by manufacturing process 111. Manufacturing process 111 may include any process for manufacturing 102 product 104. For example, without limitation, manufacturing process 111 may include a process for assembling 106 aircraft 108 or other product 110.

Manufacturing process 111 may comprise plurality of tasks 112. Plurality of tasks 112 may include various tasks that may be performed to make product 104. Plurality of tasks 112 also may be referred to as jobs, steps, or using other appropriate terminology.

Time for manufacturing 114 may refer to the amount of time that it may take to manufacture product 104 by manufacturing process 111. For example, time for manufacturing 114 may be the amount of time for completing number of tasks 112. Time for manufacturing 114 also may refer to the time that it may take to perform a part of manufacturing process 111. For example, without limitation, time for manufacturing 114 may include time for assembling 116.

Plurality of tasks 112 may be interrelated. For example, one or more of plurality of tasks 112 may not be started or completed until others of plurality of tasks 112 are started or completed. Delays in one or more of plurality of tasks 112 thus may affect other ones of plurality of tasks 112. Delays in one or more of plurality of tasks 112 also may affect time for manufacturing 114.

In accordance with an illustrative embodiment, the relationships between plurality of tasks 112 may be defined by statistical correlations 118. For example, statistical correlations 118 may define the relationships between pairs of task in plurality of tasks 112. Statistical correlations 118 also may define the relationships between groups of tasks in plurality of tasks 112, between individual tasks and groups of tasks in plurality of tasks 112, or both.

For example, first task 120 in plurality of tasks 112 may be correlated with number of correlated tasks 122 in plurality of tasks 112. The relationships between first task 120 and number of correlated tasks 122 may be defined by statistical correlations 118. Delay 124 in first task 120 may affect number of correlated tasks 122. For example, delay 124 in first task 120 may cause delays in number of correlated tasks 122. Delay 124 in first task 120 also may affect time for manufacturing 114 of product 104. In accordance with an illustrative embodiment, the effect of delay 124 in first task 120 on number of correlated tasks 122, on time for manufacturing 114, or both may be identified using statistical correlations 118.

In accordance with an illustrative embodiment, manufacturing process status monitor 126 may be configured to identify statistical correlations 118 between plurality of tasks 112. As will be discussed in more detail below, statistical correlations 118 may be identified from historical information.

Manufacturing process status monitor 126 may be configured for monitoring the status of manufacturing process 111 using statistical correlations 118 between plurality of tasks 112. For example, manufacturing process status monitor 126 may be used to identify the effect of delay 124 in first task 120 on number of correlated tasks 122, on time for manufacturing 114, or both using statistical correlations 118.

Manufacturing process status monitor 126 may be used for real-time manufacturing status monitoring 128 using statistical correlations 118 between plurality of tasks 112. Real-time manufacturing status monitoring 128 may include monitoring on-going tasks and future tasks in plurality of tasks 112 using statistical correlations 118. Manufacturing process status monitor 126 also may be used for prediction of future manufacturing status 130. Prediction of future manufacturing status 130 may be made based on the current status of manufacturing process 111 as identified by manufacturing process status monitor 126 and using statistical correlations 118 between plurality of tasks 112.

In accordance with an illustrative embodiment, manufacturing process 111 may be controlled using statistical correlations 118 between plurality of tasks 112 comprising manufacturing process 111. For example, manufacturing process controller 132 may be configured to control manufacturing process 111 using statistical correlations 118 as identified by manufacturing process status monitor 126. For example, without limitation, order of tasks 134 for performing manufacturing process 111 may be controlled using statistical correlations 118 between plurality of tasks 112. Order of tasks 134 may define the order in which plurality of tasks 112 are performed to perform manufacturing process 111. For example, without limitation, manufacturing process controller 132 may be configured to optimize order of tasks 134 using statistical correlations 118.

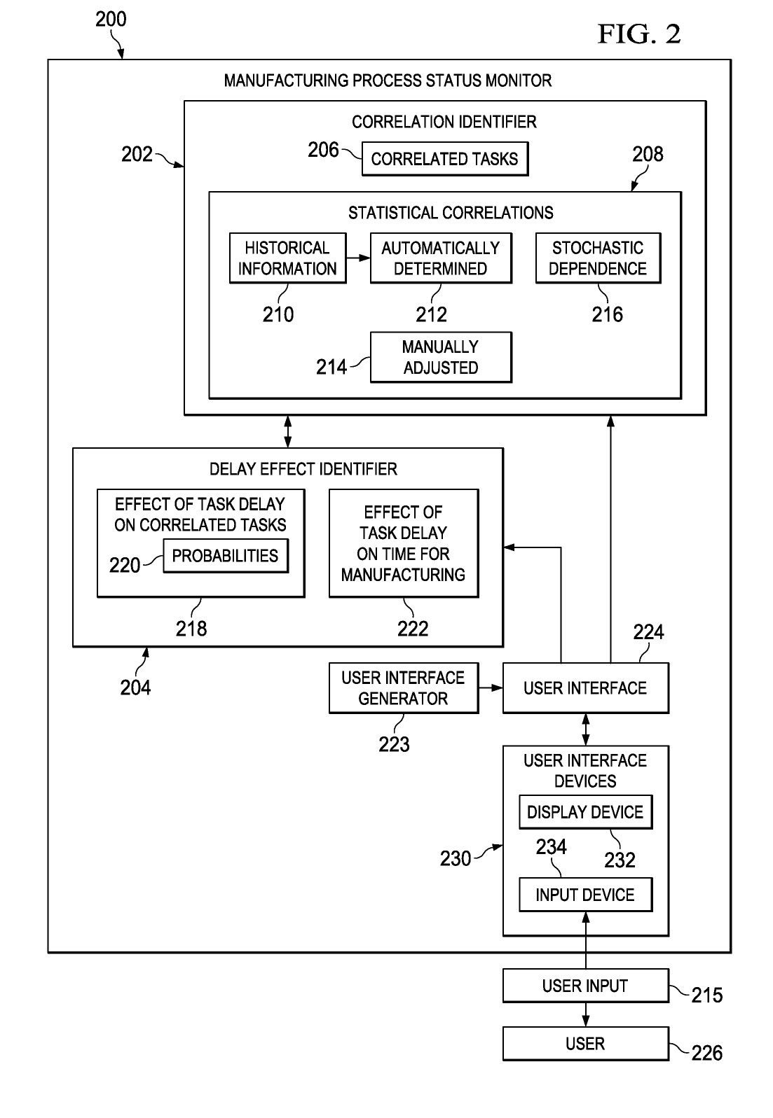

Turning now to FIG. 2, an illustration of a block diagram of a manufacturing process status monitor is depicted in accordance with an illustrative embodiment. In this example, manufacturing process status monitor 200 is an example of one implementation of manufacturing process status monitor 126 in FIG. 1.

Manufacturing process status monitor 200 may include correlation identifier 202. Correlation identifier 202 may be configured to identify correlated tasks 206 and statistical correlations 208 in a plurality of tasks comprising a manufacturing process. Statistical correlations 208 define the relationships between correlated tasks 206.

Statistical correlations 208 between a plurality of tasks comprising a manufacturing process may be identified from historical information 210. For example, without limitation, historical information 210 may include historical information for the manufacturing process for which statistical correlations 208 are being identified. Alternatively, or additionally, historical information 210 may include historical information for a manufacturing process that may be similar to the manufacturing process for which statistical correlations 208 are being identified. Historical information 210 may be obtained and provided to manufacturing process status monitor 200 in any appropriate manner.

For example, without limitation, statistical correlations 208 may be automatically determined 212 from historical information 210. Statistical correlations 208 that are automatically determined 212 may be manually adjusted 214. For example, statistical correlations 208 may be manually adjusted in response to user input 215.

Statistical correlations 208 may identify stochastic dependence 216 between the plurality of tasks comprising a manufacturing process. Statistical correlations 208 may be identified from historical information 210 using known techniques for measuring stochastic dependence 216. For example, without limitation, statistical correlations 208 may be identified using global measures of dependence, local measures of dependence, other measures of dependence, or various measures of dependence in combination. Examples of global measures of dependence that may be used to identify statistical correlations 208 may include Pearson's rho, Kendall's tau, and Spearman's rho.

Manufacturing process status monitor 200 may include delay effect identifier 204. Delay effect identifier 204 may be configured to identify effect of task delay on correlated tasks 218 using statistical correlations 208. Effect of task delay on correlated tasks 218 may identify the effects of a delay of one task in a plurality of tasks comprising a manufacturing process on correlated tasks in the plurality of tasks. For example, without limitation, effect of task delay on correlated tasks 218 may include an indication of probabilities 220 that a delay of one of the plurality of tasks comprising a manufacturing process may affect other ones of the plurality of tasks.

Delay effect identifier 204 also may be configured to identify effect of task delay on time for manufacturing 222 using statistical correlations 208. Effect of task delay on time for manufacturing 222 may identify the effect of a delay of a number of tasks in a plurality of tasks comprising a manufacturing process on the time for manufacturing a product using the manufacturing process. Therefore, effect of task delay on time for manufacturing 222 may identify the effect of a delay of a number of tasks in a plurality of tasks comprising a manufacturing process on the manufacturing process as whole.

Manufacturing process status monitor 200 may include user interface generator 223. User interface generator 223 may be configured to generate user interface 224 for manufacturing process status monitor 200. For example, without limitation, user interface 224 may be a graphical user interface or other user interface.

User 226 may interact with user interface 224 via user interface devices 230. User interface devices 230 may include any appropriate devices for displaying user interface 224 to user 226 and for receiving user input 215 from user 226. For example, user interface 224 may be displayed to user 226 on display device 232. User 226 may use input device 234 to provide user input 215 to user interface 224.

User interface 224 may be configured to allow user 226 to interact with manufacturing process status monitor 200. For example, user interface 224 may be configured to allow user 226 to provide user input 215 to manufacturing process status monitor 200 for controlling correlation identifier 202, delay effect identifier 204, or both. Effect of task delay on correlated tasks 218, effect of task delay on time for manufacturing 222, or both may be displayed to user 226 on user interface 224.

The illustrations of FIG. 1 and FIG. 2 are not meant to imply physical or architectural limitations to the manner in which different illustrative embodiments may be implemented. Other components in addition to, in place of, or both in addition to and in place of the ones illustrated may be used. Some components may be unnecessary in some illustrative embodiments. Also, the blocks are presented to illustrate some functional components. One or more of these blocks may be combined or divided into different blocks when implemented in different illustrative embodiments.

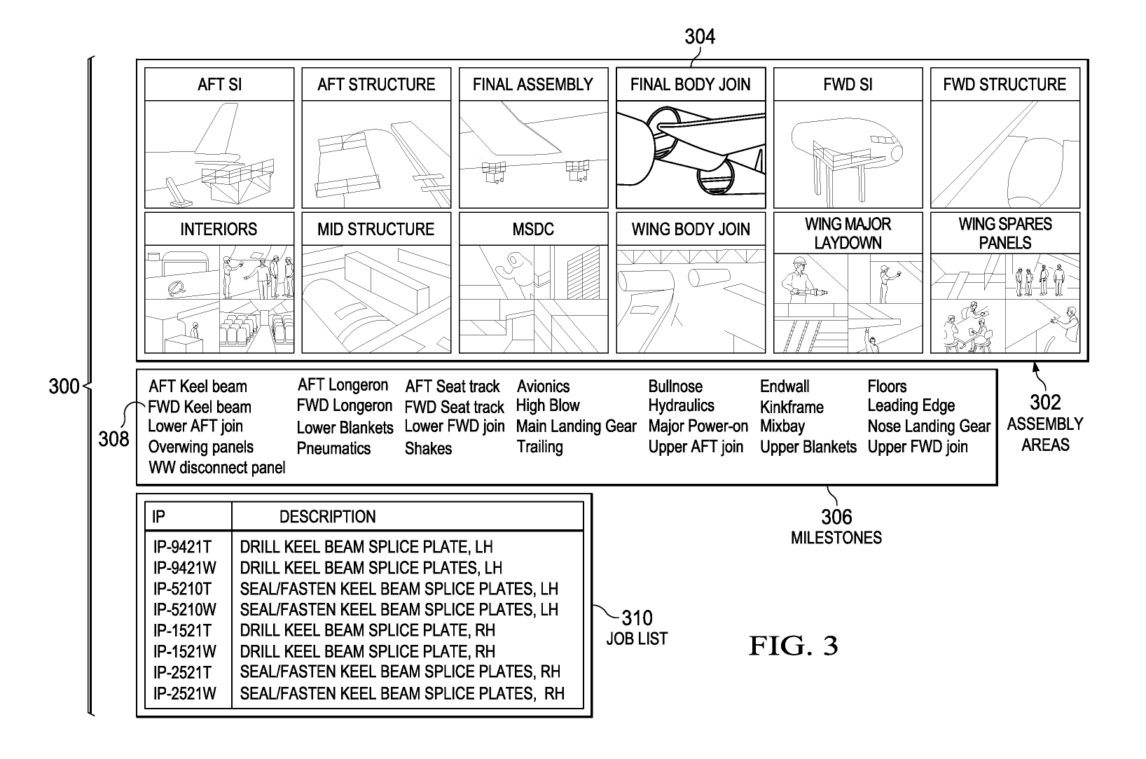

Turning now to FIG. 3, an illustration of a user interface is depicted in accordance with an illustrative embodiment. In this example, user interface 300 is an example of one implementation of user interface 224 for manufacturing process status monitor 200 in FIG. 2. In this example, user interface 300 is configured to allow a user to select a task from a plurality of tasks for assembling an aircraft.

User interface 300 may include a number of virtual buttons 302 corresponding to various assembly areas for assembling the aircraft. The user may first select an assembly area from the displayed number of assembly areas. In this example, the user has selected virtual button 304 for the “Final Body Join” assembly area.

In response to selecting one of virtual buttons 302 corresponding to a selected assembly area, a list of milestones 306 corresponding to the selected assembly area may be displayed on user interface 300. In this example, list of milestones 306 is a list of milestones corresponding to the selected “Final Body Join” assembly area. The user then may select one of the listed milestones 306. In this example, the user has selected “FWD Keel beam” 308 from list of milestones 306.

In response to selecting one milestone from list of milestones 306, job list 310 corresponding to the selected milestone may be displayed on user interface 300. Job list 310 also may be referred to as a list of installation plans or tasks for assembling the aircraft. In this example, job list 310 is a list of installation plans corresponding to the selected “FWD Keel beam” milestone. The user may select one of the installation plans from job list 310 to display the effect of a delay in the selected installation plan on other installation plans in the process of assembling the aircraft.

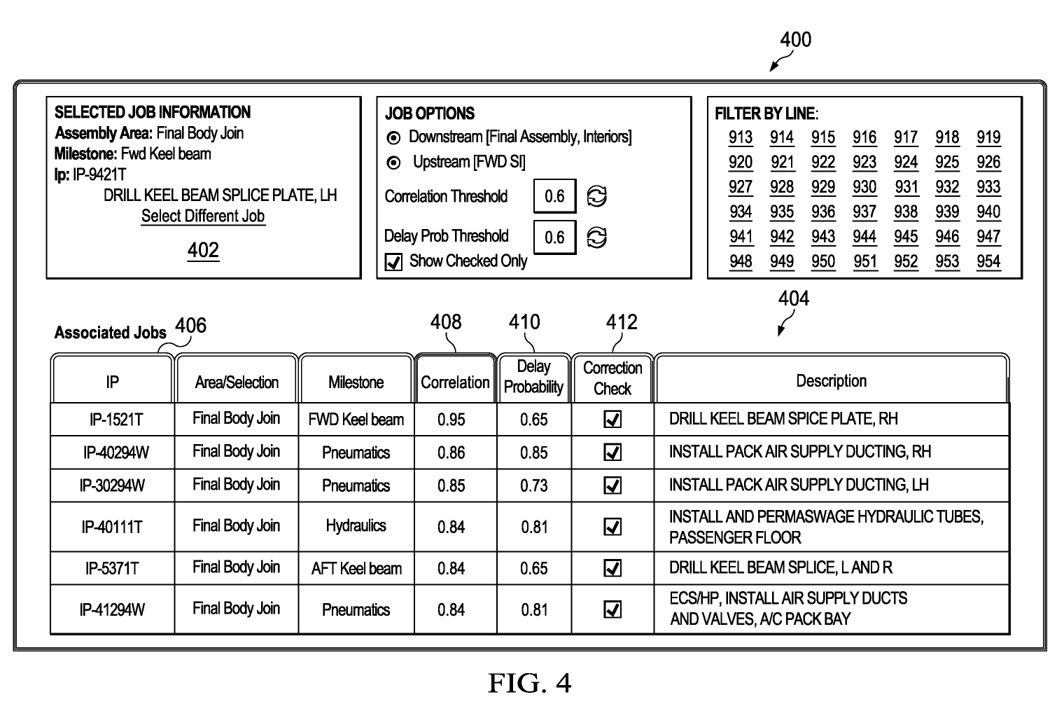

Turning now to FIG. 4, an illustration of another user interface is depicted in accordance with an illustrative embodiment. In this example, user interface 400 is an example of another implementation of user interface 224 for manufacturing process status monitor 200 in FIG. 2. In this example, user interface 400 is an example of a user interface that may be displayed in response to selecting “DRILL KEEL BEAM SPLICE PLATE, STA 1035, LH” from the list of installation plans in user interface 300 in FIG. 3.

In this example, user interface 400 is configured to show the correlation between a selected task and a number of correlated tasks. User interface 400 also is configured to show the probabilities that a delay in the selected task will affect the number of correlated tasks.

User interface 400 may include display 402 identifying the selected installation plan. User interface 400 may include display 404 identifying correlated installation plans 406 that are correlated to the selected installation plan, correlations 408 between the selected installation plan and each of correlated installation plans 406, and delay probabilities 410 for each of correlated installation plans 406. In this example, delay probabilities 410 indicate the probabilities that each of correlated installation plans 406 will be delayed if the selected installation plan is delayed.

Display 404 may include correction check boxes 412 for each of correlated installation plans 406. Authorized users may select correction check boxes 412 to change manually the information presented in display 404 for corresponding installation plans 406.

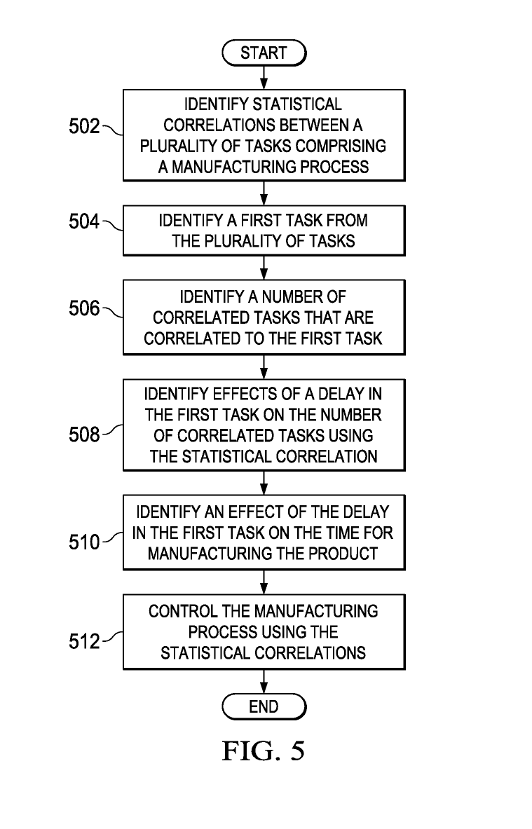

Turning now to FIG. 5, an illustration of a flowchart of a process for controlling a manufacturing process is depicted in accordance with an illustrative embodiment. For example, the process illustrated in FIG. 5 may be implemented in manufacturing environment 100 using manufacturing process status monitor 126 and manufacturing process controller 132 in FIG. 1.

The process may begin by identifying statistical correlations between a plurality of tasks comprising a manufacturing process (operation 502). Statistical correlations between the plurality of tasks may be identified using historical manufacturing information.

A first task from the plurality of tasks may be identified (operation 504). A number of correlated tasks that are correlated to the first task may be identified using the statistical correlations (operation 506). An effect of a delay in the first task on the number of correlated tasks may be identified using the statistical correlations (operation 508). For example, without limitation, operation 508 may include identifying probabilities that a delay in the first task may affect the number of correlated tasks. An effect of the delay in the first task on a time for manufacturing also may be identified using the statistical correlations (operation 510).

The manufacturing process may be controlled using the statistical correlations (operation 512), with the process terminating thereafter. For example, without limitation, operation 512 may include optimizing the order in which the plurality of tasks comprising the manufacturing process is performed.

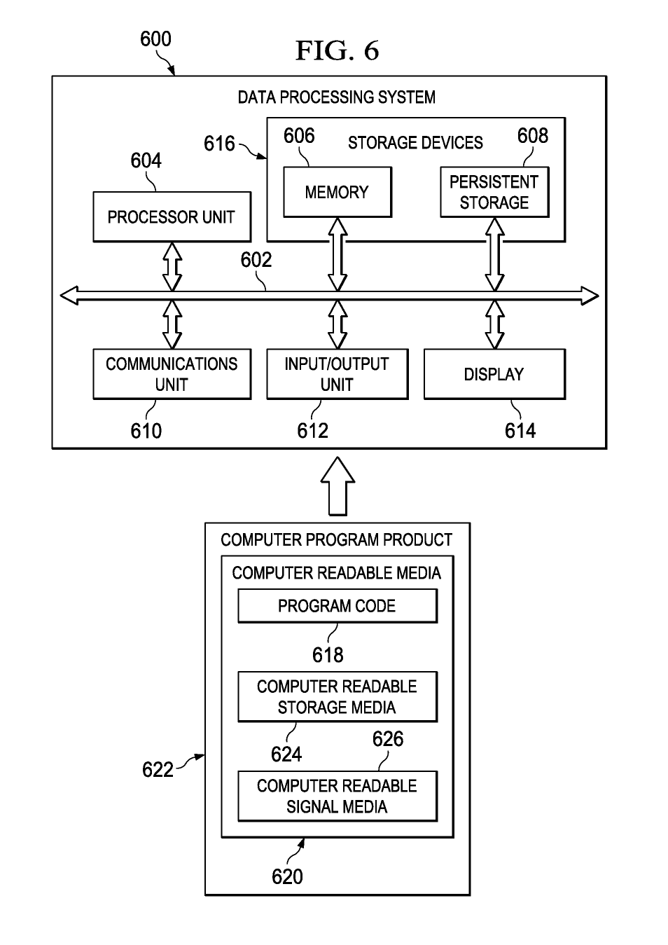

Turning now to FIG. 6, an illustration of a block diagram of a data processing system is depicted in accordance with an illustrative embodiment. In this example, data processing system 600 is an example of one implementation of a data processing system for implementing manufacturing process status monitor 126 or manufacturing process controller 132 in FIG. 1 or manufacturing process status monitor 200 in FIG. 2.

In this illustrative example, data processing system 600 includes communications fabric 602. Communications fabric 602 provides communications between processor unit 604, memory 606, persistent storage 608, communications unit 610, input/output (I/O) unit 612, and display 614. Memory 606, persistent storage 608, communications unit 610, input/output (I/O) unit 612, and display 614 are examples of resources accessible by processor unit 604 via communications fabric 602.

Processor unit 604 serves to run instructions for software that may be loaded into memory 606. Processor unit 604 may be a number of processors, a multi-processor core, or some other type of processor, depending on the particular implementation. Further, processor unit 604 may be implemented using a number of heterogeneous processor systems in which a main processor is present with secondary processors on a single chip. As another illustrative example, processor unit 604 may be a symmetric multi-processor system containing multiple processors of the same type.

Memory 606 and persistent storage 608 are examples of storage devices 616. A storage device is any piece of hardware that is capable of storing information, such as, for example, without limitation, data, program code in functional form, and other suitable information either on a temporary basis or a permanent basis. Storage devices 616 also may be referred to as computer readable storage devices in these examples. Memory 606, in these examples, may be, for example, a random access memory or any other suitable volatile or non-volatile storage device. Persistent storage 608 may take various forms, depending on the particular implementation.

For example, persistent storage 608 may contain one or more components or devices. For example, persistent storage 608 may be a hard drive, a flash memory, a rewritable optical disk, a rewritable magnetic tape, or some combination of the above. The media used by persistent storage 608 also may be removable. For example, a removable hard drive may be used for persistent storage 608.

Communications unit 610, in these examples, provides for communications with other data processing systems or devices. In these examples, communications unit 610 is a network interface card. Communications unit 610 may provide communications through the use of either or both physical and wireless communications links.

Input/output (I/O) unit 612 allows for input and output of data with other devices that may be connected to data processing system 600. For example, input/output (I/O) unit 612 may provide a connection for user input through a keyboard, a mouse, and/or some other suitable input device. Further, input/output (I/O) unit 612 may send output to a printer. Display 614 provides a mechanism to display information to a user.

Instructions for the operating system, applications, and/or programs may be located in storage devices 616, which are in communication with processor unit 604 through communications fabric 602. In these illustrative examples, the instructions are in a functional form on persistent storage 608. These instructions may be loaded into memory 606 for execution by processor unit 604. The processes of the different embodiments may be performed by processor unit 604 using computer-implemented instructions, which may be located in a memory, such as memory 606.

These instructions are referred to as program instructions, program code, computer usable program code, or computer readable program code that may be read and executed by a processor in processor unit 604. The program code in the different embodiments may be embodied on different physical or computer readable storage media, such as memory 606 or persistent storage 608.

Program code 618 is located in a functional form on computer readable media 620 that is selectively removable and may be loaded onto or transferred to data processing system 600 for execution by processor unit 604. Program code 618 and computer readable media 620 form computer program product 622 in these examples. In one example, computer readable media 620 may be computer readable storage media 624 or computer readable signal media 626.

Computer readable storage media 624 may include, for example, an optical or magnetic disk that is inserted or placed into a drive or other device that is part of persistent storage 608 for transfer onto a storage device, such as a hard drive, that is part of persistent storage 608. Computer readable storage media 624 also may take the form of a persistent storage, such as a hard drive, a thumb drive, or a flash memory, that is connected to data processing system 600. In some instances, computer readable storage media 624 may not be removable from data processing system 600.

In these examples, computer readable storage media 624 is a physical or tangible storage device used to store program code 618 rather than a medium that propagates or transmits program code 618. Computer readable storage media 624 is also referred to as a computer readable tangible storage device or a computer readable physical storage device. In other words, computer readable storage media 624 is a media that can be touched by a person.

Alternatively, program code 618 may be transferred to data processing system 600 using computer readable signal media 626. Computer readable signal media 626 may be, for example, a propagated data signal containing program code 618. For example, computer readable signal media 626 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, program code 618 may be downloaded over a network to persistent storage 608 from another device or data processing system through computer readable signal media 626 for use within data processing system 600. For instance, program code stored in a computer readable storage medium in a server data processing system may be downloaded over a network from the server to data processing system 600. The data processing system providing program code 618 may be a server computer, a client computer, or some other device capable of storing and transmitting program code 618.

The different components illustrated for data processing system 600 are not meant to provide architectural limitations to the manner in which different embodiments may be implemented. The different illustrative embodiments may be implemented in a data processing system including components in addition to and/or in place of those illustrated for data processing system 600. Other components shown in FIG. 6 can be varied from the illustrative examples shown. The different embodiments may be implemented using any hardware device or system capable of running program code. As one example, data processing system 600 may include organic components integrated with inorganic components and/or may be comprised entirely of organic components excluding a human being. For example, a storage device may be comprised of an organic semiconductor.

In another illustrative example, processor unit 604 may take the form of a hardware unit that has circuits that are manufactured or configured for a particular use. This type of hardware may perform operations without needing program code to be loaded into a memory from a storage device to be configured to perform the operations.

For example, when processor unit 604 takes the form of a hardware unit, processor unit 604 may be a circuit system, an application specific integrated circuit (ASIC), a programmable logic device, or some other suitable type of hardware configured to perform a number of operations. With a programmable logic device, the device is configured to perform the number of operations. The device may be reconfigured at a later time or may be permanently configured to perform the number of operations. Examples of programmable logic devices include, for example, a programmable logic array, a programmable array logic, a field programmable logic array, a field programmable gate array, and other suitable hardware devices. With this type of implementation, program code 618 may be omitted, because the processes for the different embodiments are implemented in a hardware unit.

In still another illustrative example, processor unit 604 may be implemented using a combination of processors found in computers and hardware units. Processor unit 604 may have a number of hardware units and a number of processors that are configured to run program code 618. With this depicted example, some of the processes may be implemented in the number of hardware units, while other processes may be implemented in the number of processors.

In another example, a bus system may be used to implement communications fabric 602 and may be comprised of one or more buses, such as a system bus or an input/output bus. Of course, the bus system may be implemented using any suitable type of architecture that provides for a transfer of data between different components or devices attached to the bus system.

Additionally, communications unit 610 may include a number of devices that transmit data, receive data, or both transmit and receive data. Communications unit 610 may be, for example, a modem or a network adapter, two network adapters, or some combination thereof. Further, a memory may be, for example, memory 606, or a cache, such as that found in an interface and memory controller hub that may be present in communications fabric 602.

The flowcharts and block diagrams described herein illustrate the architecture, functionality, and operation of possible implementations of systems, methods, and computer program products according to various illustrative embodiments. In this regard, each block in the flowcharts or block diagrams may represent a module, segment, or portion of code, which comprises one or more executable instructions for implementing the specified logical function or functions. It should also be noted that, in some alternative implementations, the functions noted in a block may occur out of the order noted in the figures. For example, the functions of two blocks shown in succession may be executed substantially concurrently, or the functions of the blocks may sometimes be executed in the reverse order, depending upon the functionality involved.

The description of the different illustrative embodiments has been presented for purposes of illustration and description and is not intended to be exhaustive or to limit the embodiments in the form disclosed. Many modifications and variations will be apparent to those of ordinary skill in the art. Further, different illustrative embodiments may provide different benefits as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method for controlling a manufacturing process, comprising:
identifying, by a processor unit, statistical correlations between a plurality of tasks comprising the manufacturing process; and
controlling the manufacturing process using the statistical correlations.

2. The method of claim 1, wherein controlling the manufacturing process comprises controlling an order in which the plurality of tasks are performed using the statistical correlations.

3. The method of claim 1, wherein identifying the statistical correlations comprises identifying the statistical correlations using historical information for the manufacturing process.

4. The method of claim 3 further comprising manually adjusting the statistical correlations.

5. The method of claim 1, wherein the statistical correlations identify stochastic dependence between the plurality of tasks.

6. The method of claim 1 further comprising:
identifying, by the processor unit, an effect of a delay in a first task in the plurality of tasks on a number of correlated tasks in the plurality of tasks using the statistical correlations.

7. The method of claim 6, wherein identifying the effect of the delay in the first task on the number of correlated tasks comprises identifying probabilities that the delay in the first task will result in a delay in the number of correlated tasks.

8. The method of claim 1 further comprising:
identifying, by the processor unit, an effect of a delay in a first task in the plurality of tasks on a time for manufacturing a product using the manufacturing process.

9. The method of claim 1, wherein the manufacturing process comprises a process for assembling an aircraft.

10. An apparatus, comprising:
a manufacturing process status monitor configured to identify statistical correlations between a plurality of tasks comprising a manufacturing process; and
a manufacturing process controller configured to control the manufacturing process using the statistical correlations.

11. The apparatus of claim 10, wherein the manufacturing process controller is configured to control an order in which the plurality of tasks is performed using the statistical correlations.

12. The apparatus of claim 10, wherein the manufacturing process status monitor is configured to identify the statistical correlations using historical information for the manufacturing process.

13. The apparatus of claim 12, wherein the manufacturing process status monitor is configured to receive user input from a user and to adjust the statistical correlations responsive to the user input.

14. The apparatus of claim 10, wherein the statistical correlations identify stochastic dependence between the plurality of tasks.

15. The apparatus of claim 10, wherein the manufacturing process status monitor is configured to identify an effect of a delay in a first task in the plurality of tasks on a number of correlated tasks in the plurality of tasks using the statistical correlations.

16. The apparatus of claim 15, wherein the manufacturing process status monitor is configured to identify probabilities that the delay in the first task will result in a delay in the number of correlated tasks.

17. The apparatus of claim 10, wherein the manufacturing process status monitor is configured to identify an effect of a delay in a first task in the plurality of tasks on a time for manufacturing a product using the manufacturing process.

18. The apparatus of claim 10, wherein the manufacturing process comprises a process for assembling an aircraft.

19. A method for controlling a process for assembling an aircraft, comprising:
identifying, by a processor unit, statistical correlations between a plurality of tasks for assembling the aircraft;
identifying, by the processor unit, a first task from the plurality of tasks for assembling the aircraft;
identifying, by the processor unit, a number of correlated tasks from the plurality of tasks for assembling the aircraft using the statistical correlations; and
identifying, by the processor unit, an effect of a delay in the first task on the number of correlated tasks using the statistical correlations.

20. The method of claim 19, wherein identifying the effect of the delay in the first task on the number of correlated tasks comprises identifying probabilities that the delay in the first task will result in a delay in the number of correlated tasks.
